(19) United States
(12) Patent Application Publication
(10) Pub. No.: US 2021/0012281 A1
(43) Pub. Date: Jan. 14, 2021

(54) SYSTEM AND METHOD FOR MANAGING INVENTORY THROUGH RETURN LABELS

(71) Applicant: SHOPIFY INC., Ottawa (CA)

(72) Inventors: RAPHAEL PAQUIN, MONTREAL (CA); GUILLAUME RACINE, MONTREAL (CA)

(21) Appl. No.: 16/506,548

(22) Filed: Jul. 9, 2019

(51) Int. Cl. G06Q 10/08

(52) U.S. Cl. CPC G06Q 10/0837; B42D 15/006; G06Q 10/087

(57) ABSTRACT

Systems and methods are provided for processing returned items based on related inventory through the use of return labels. Rather than simply return everything to the same location, current inventory is considered in choosing a location for the return, and a suitable return label is sent to the customer. This may be a physical return label, a printable return label sent electronically. Alternatively, an attachable device such as an IoT chipset is sent to the customer.

### FIELD

The application relates to systems and methods for processing returned items.

### BACKGROUND

Buyers may purchase items through a number of different channels, including physical point of sale locations, online through a web-based store, or via mobile apps, to name a few examples.

Typically, for various reasons, some percentage of buyers will want to return their purchase. This can also occur via different physical channels, including physical store locations, and online return platforms where a buyer is directed to a physical store, or given a return label to ship the product back to +the merchant.

In conventional systems, when a buyer has purchased an item, and subsequently wants to return the item, the retailer may have multiple physical store locations, and the buyer may choose a physical store location to return the item to.

Alternatively, where the buyer interacts with an online return platform, the buyer may be directed to a physical store location most proximate to the buyer

Similarly, for online returns that are processed by sending the buyer a shipping label, the shipping label address, which defines where the return shipment will be sent, is the same for all users, or is the same at least for all users in a given area.

The cost to merchants of processing returns is significant. Any method of reducing such cost would be beneficial. The existing return processes are disadvantageous to the buyer as well. Typically, the buyer is left to wait a few to several days; first waiting for the item being returned to be received by the merchant and processed, and a replacement item being shipping back to the buyer if they are seeking an exchange. This process can often delay the use of the purchased item. Any method to decrease the time required to ensure that the buyer obtains the correct product in the shortest amount of time would be greatly beneficial.

### SUMMARY

Systems and methods are provided for processing returned items based on related inventory through the use of return labels. Rather than simply return everything to the same location, current inventory is considered in choosing a location for the return, and a suitable return label is sent to the customer. This may be a physical return label, a printable return label sent electronically. Alternatively, an attachable device such as an IoT chipset is sent to the customer.

According to one aspect of the present invention, there is provided a computer implemented method of processing a return indication, the method comprising: receiving an indication of a return of an item; obtaining related inventory information; selecting a physical return location for returning the item based on the related inventory information, wherein selecting the physical return location is based on inventory management; conveying an output associated with the selected physical return location by sending a shipping label or attachable device associated with the selected physical return location.

Optionally, conveying an output associated with the selected physical return location by sending a shipping label or attachable device associated with the selected physical return location comprises sending a physical shipping label associated with the selected physical return location.

Optionally, the physical shipping label is imprinted with a physical return address of the selected physical return location.

Optionally, the physical shipping label is imprinted with a barcode of the selected physical return location.

Optionally, the physical shipping label is imprinted with a logistics identifier associated with the selected physical return location.

Optionally, conveying an output associated with the selected physical return location by sending a shipping label or attachable device associated with the selected physical return location comprises sending electronically a printable shipping label associated with the selected physical return location.

Optionally, the printable shipping label contains a physical return address of the selected physical return location.

Optionally, the printable shipping label contains a barcode of the selected physical return location.

Optionally, the printable shipping label contains a logistics identifier associated with the selected physical return location.

Optionally, conveying an output associated with the selected physical return location by sending a shipping label or attachable device associated with the selected physical return location comprises sending an attachable device associated with the selected physical return location, the attachable device comprising an IoT (internet of things) chipset.

Optionally, obtaining the related inventory information involves using a related inventory API.

According to another aspect of the present invention, there is provided a system for processing a return indication, the system comprising: an interface for receiving an indication of a return of an item; an inventory database containing inventory for a set of physical return locations; a processor and memory configured to process the received return indication by: obtaining related inventory information from the inventory database; selecting a physical return location for returning the item based on the related inventory information, wherein selecting the physical return location is based on inventory management; conveying an output associated with the selected physical return location by sending a shipping label or attachable device associated with the selected physical return location.

Optionally, the system is configured to convey an output associated with the selected physical return location by sending a shipping label or attachable device associated with the selected physical return location by sending a physical shipping label associated with the selected physical return location.

Optionally, the physical shipping label is imprinted with a physical return address of the selected physical return location.

Optionally, the physical shipping label is imprinted with a barcode of the selected physical return location.

Optionally, the physical shipping label is imprinted with a logistics identifier associated with the selected physical return location.

Optionally, the system is configured to convey an output associated with the selected physical return location by sending a shipping label or attachable device associated with the selected physical return location by sending electronically a printable shipping label associated with the selected physical return location.

Optionally, the printable shipping label contains a physical return address of the selected physical return location.

Optionally, the printable shipping label contains a barcode of the selected physical return location.

Optionally, the printable shipping label contains a logistics identifier associated with the selected physical return location.

Optionally, to convey an output associated with the selected physical return location by sending a shipping label or attachable device associated with the selected physical return location by sending an attachable device associated with the selected physical return location, the attachable device comprising an IoT (internet of things) chipset.

Optionally, the system comprises a related inventory API for use in obtaining the related inventory information.

### BRIEF DESCRIPTION OF THE DRAWINGS

Embodiments of the disclosure will now be described with reference to the attached drawings in which:

FIG. 1 is a block diagram of an e-commerce platform, according to one embodiment;

FIG. 2 is an example of a home page of an administrator, according to one embodiment;

FIG. 3 is a block diagram of a system of processing returns to achieve inventory management;

FIG. 4 is a flowchart diagram of a method of processing returns to achieve inventory management;

FIG. 5 is a block diagram of a system of processing returns to enhance the probability of converting a return into an exchange;

FIG. 6 is a flowchart diagram of a method of processing returns to enhance the probability o converting a return into an exchange;

FIG. 7 illustrates an example of a graphical user interface (GUI) that may be implemented as the buyer facing return interface;

FIG. 8 illustrates an example of a GUI that may be used as implemented a merchant facing return configuration interface; and

FIG. 9 illustrates an example of a GUI that may be used as the merchant facing return interface.

### DETAILED DESCRIPTION

As noted above, in conventional systems, where a buyer interacts with an online return platform, the buyer may be directed by the online platform to return the item to a physical store location most proximate to the buyer. In this case, the buyer is sent to the location for return without regard to inventory, and without regard to extra information about the buyer (other than location).

Similarly, existing approaches to processing online returns that are handled by sending the buyer a shipping label, this is done without regard to inventory, and without regard to extra information about the buyer (other than location).

In addition, with existing systems, there is no systematic approach to attempt to modify a buyer's behaviour such that rather than returning the item completely, the buyer exchanges the item for another item from the same merchant.

The cost to merchants of processing returns is significant both in terms of the lost sales opportunity the return represents, and in terms of the physical cost of returning the item, typically to a central location, and then re-stocking the item by shipping it back out to an appropriate location.

In embodiments of the application, systems and methods are provided for processing returned items based on related inventory. In some embodiments, the systems and methods process returns in order to perform some inventory management through return processing. In other embodiments, the systems and methods process returns in a manner that increases a probability that the buyer will exchange the item for another item rather than simply return the item. In some embodiments, the two objectives are combined, such that the return is processed in a manner that facilitates some inventory management, but also increases a probability that the buyer will exchange the item for another item rather than simply returning the item.

The present disclosure will now be described in detail by describing various illustrative, non-limiting embodiments thereof with reference to the accompanying drawings and exhibits. The disclosure may, however, be embodied in many different forms and should not be construed as being limited to the illustrative embodiments set forth herein. Rather, the embodiments are provided so that this disclosure will be thorough and will fully convey the concept of the disclosure to those skilled in the art.

The description is focused on implementation of the systems and methods for processing of late arriving data for use in e-commerce platforms. However, it should be understood that the same approach can be applied in other systems that are sensitive to the arrival time of data. In another example, these approaches are applied to streaming systems and services, for example systems for streaming video or music.

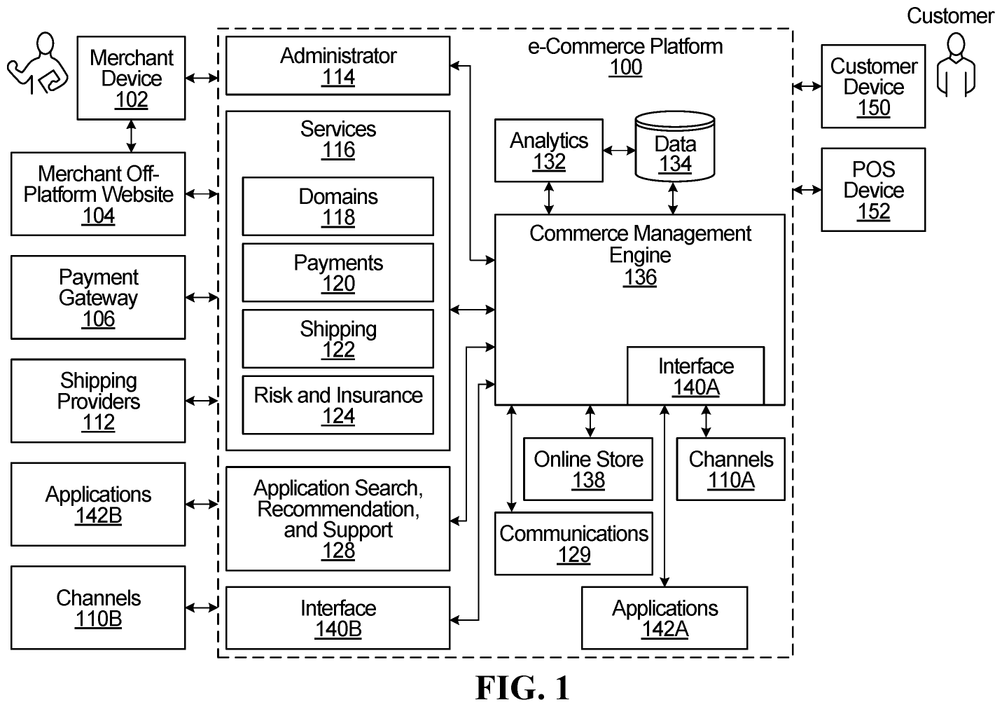

With reference to FIG. 1, an embodiment e-commerce platform 100 is depicted for providing merchant products and services to customers. While the disclosure throughout contemplates using the apparatus, system, and process disclosed to purchase products and services, for simplicity the description herein will refer to products. All references to products throughout this disclosure should also be understood to be references to products and/or services, including physical products, digital content, tickets, subscriptions, services to be provided, and the like.

While the disclosure throughout contemplates that a ‘merchant’ and a ‘customer’ may be more than individuals, for simplicity the description herein may generally refer to merchants and customers as such. All references to merchants and customers throughout this disclosure should also be understood to be references to groups of individuals, companies, corporations, computing entities, and the like, and may represent for-profit or not-for-profit exchange of products. Further, while the disclosure throughout refers to ‘merchants’ and ‘customers’, and describes their roles as such, the e-commerce platform 100 should be understood to more generally support users in an e-commerce environment, and all references to merchants and customers throughout this disclosure should also be understood to be references to users, such as where a user is a merchant-user (e.g., a seller, retailer, wholesaler, or provider of products), a customer-user (e.g., a buyer, purchase agent, or user of products), a prospective user (e.g., a user browsing and not yet committed to a purchase, a user evaluating the e-commerce platform 100 for potential use in marketing and selling products, and the like), a service provider user (e.g., a shipping provider 112, a financial provider, and the like), a company or corporate user (e.g., a company representative for purchase, sales, or use of products; an enterprise user; a customer relations or customer management agent, and the like), an information technology user, a computing entity user (e.g., a computing bot for purchase, sales, or use of products), and the like.

The e-commerce platform 100 may provide a centralized system for providing merchants with online resources and facilities for managing their business. The facilities described herein may be deployed in part or in whole through a machine that executes computer software, modules, program codes, and/or instructions on one or more processors which may be part of or external to the platform 100. Merchants may utilize the e-commerce platform 100 for managing commerce with customers, such as by implementing an e-commerce experience with customers through an online store 138, through channels 110A-B, through POS devices 152 in physical locations (e.g., a physical storefront or other location such as through a kiosk, terminal, reader, printer, 3D printer, and the like), by managing their business through the e-commerce platform 100, and by interacting with customers through a communications facility 129 of the e-commerce platform 100, or any combination thereof. A merchant may utilize the e-commerce platform 100 as a sole commerce presence with customers, or in conjunction with other merchant commerce facilities, such as through a physical store (e.g., ‘brick-and-mortar’ retail stores), a merchant off-platform website 104 (e.g., a commerce Internet website or other internet or web property or asset supported by or on behalf of the merchant separately from the e-commerce platform), and the like. However, even these ‘other’ merchant commerce facilities may be incorporated into the e-commerce platform, such as where POS devices 152 in a physical store of a merchant are linked into the e-commerce platform 100, where a merchant off-platform website 104 is tied into the e-commerce platform 100, such as through ‘buy buttons’ that link content from the merchant off platform website 104 to the online store 138, and the like.

The online store 138 may represent a multitenant facility comprising a plurality of virtual storefronts. In embodiments, merchants may manage one or more storefronts in the online store 138, such as through a merchant device 102 (e.g., computer, laptop computer, mobile computing device, and the like), and offer products to customers through a number of different channels 110A-B (e.g., an online store 138; a physical storefront through a POS device 152; electronic marketplace, through an electronic buy button integrated into a website or social media channel such as on a social network, social media page, social media messaging system; and the like). A merchant may sell across channels 110A-B and then manage their sales through the e-commerce platform 100, where channels 110A may be provided internal to the e-commerce platform 100 or from outside the e-commerce channel 110B. A merchant may sell in their physical retail store, at pop ups, through wholesale, over the phone, and the like, and then manage their sales through the e-commerce platform 100. A merchant may employ all or any combination of these, such as maintaining a business through a physical storefront utilizing POS devices 152, maintaining a virtual storefront through the online store 138, and utilizing a communication facility 129 to leverage customer interactions and analytics 132 to improve the probability of sales. Throughout this disclosure the terms online store 138 and storefront may be used synonymously to refer to a merchant's online e-commerce offering presence through the e-commerce platform 100, where an online store 138 may refer to the multitenant collection of storefronts supported by the e-commerce platform 100 (e.g., for a plurality of merchants) or to an individual merchant's storefront (e.g., a merchant's online store).

In embodiments, a customer may interact through a customer device 150 (e.g., computer, laptop computer, mobile computing device, and the like), a POS device 152 (e.g., retail device, a kiosk, an automated checkout system, and the like), or any other commerce interface device known in the art. The e-commerce platform 100 may enable merchants to reach customers through the online store 138, through POS devices 152 in physical locations (e.g., a merchant's storefront or elsewhere), to promote commerce with customers through dialog via electronic communication facility 129, and the like, providing a system for reaching customers and facilitating merchant services for the real or virtual pathways available for reaching and interacting with customers.

In embodiments, and as described further herein, the e-commerce platform 100 may be implemented through a processing facility including a processor and a memory, the processing facility storing a set of instructions that, when executed, cause the e-commerce platform 100 to perform the e-commerce and support functions as described herein. The processing facility may be part of a server, client, network infrastructure, mobile computing platform, cloud computing platform, stationary computing platform, or other computing platform, and provide electronic connectivity and communications between and amongst the electronic components of the e-commerce platform 100, merchant devices 102, payment gateways 106, application developers, channels 110A-B, shipping providers 112, customer devices 150, point of sale devices 152, and the like. The e-commerce platform 100 may be implemented as a cloud computing service, a software as a service (SaaS), infrastructure as a service (IaaS), platform as a service (PaaS), desktop as a Service (DaaS), managed software as a service (MSaaS), mobile backend as a service (MBaaS), information technology management as a service (ITMaaS), and the like, such as in a software and delivery model in which software is licensed on a subscription basis and centrally hosted (e.g., accessed by users using a client (for example, a thin client) via a web browser or other application, accessed through by POS devices, and the like). In embodiments, elements of the e-commerce platform 100 may be implemented to operate on various platforms and operating systems, such as iOS, Android, on the web, and the like (e.g., the administrator 114 being implemented in multiple instances for a given online store for iOS, Android, and for the web, each with similar functionality).

In embodiments, the online store 138 may be served to a customer device 150 through a webpage provided by a server of the e-commerce platform 100. The server may receive a request for the webpage from a browser or other application installed on the customer device 150, where the browser (or other application) connects to the server through an IP Address, the IP address obtained by translating a domain name. In return, the server sends back the requested webpage. Webpages may be written in or include Hypertext Markup Language (HTML), template language, JavaScript, and the like, or any combination thereof. For instance, HTML is a computer language that describes static information for the webpage, such as the layout, format, and content of the webpage. Website designers and developers may use the template language to build webpages that combine static content, which is the same on multiple pages, and dynamic content, which changes from one page to the next. A template language may make it possible to re-use the static elements that define the layout of a webpage, while dynamically populating the page with data from an online store. The static elements may be written in HTML, and the dynamic elements written in the template language. The template language elements in a file may act as placeholders, such that the code in the file is compiled and sent to the customer device 150 and then the template language is replaced by data from the online store 138, such as when a theme is installed. The template and themes may consider tags, objects, and filters. The client device web browser (or other application) then renders the page accordingly.

In embodiments, online stores 138 may be served by the e-commerce platform 100 to customers, where customers can browse and purchase the various products available (e.g., add them to a cart, purchase immediately through a buy-button, and the like). Online stores 138 may be served to customers in a transparent fashion without customers necessarily being aware that it is being provided through the e-commerce platform 100 (rather than directly from the merchant). Merchants may use a merchant configurable domain name, a customizable HTML theme, and the like, to customize their online store 138. Merchants may customize the look and feel of their website through a theme system, such as where merchants can select and change the look and feel of their online store 138 by changing their theme while having the same underlying product and business data shown within the online store's product hierarchy. Themes may be further customized through a theme editor, a design interface that enables users to customize their website's design with flexibility. Themes may also be customized using theme-specific settings that change aspects, such as specific colors, fonts, and pre-built layout schemes. The online store may implement a content management system for website content. Merchants may author blog posts or static pages and publish them to their online store 138, such as through blogs, articles, and the like, as well as configure navigation menus. Merchants may upload images (e.g., for products), video, content, data, and the like to the e-commerce platform 100, such as for storage by the system (e.g. as data 134). In embodiments, the e-commerce platform 100 may provide functions for resizing images, associating an image with a product, adding and associating text with an image, adding an image for a new product variant, protecting images, and the like.

As described herein, the e-commerce platform 100 may provide merchants with transactional facilities for products through a number of different channels 110A-B, including the online store 138, over the telephone, as well as through physical POS devices 152 as described herein. The e-commerce platform 100 may include business support services 116, an administrator 114, and the like associated with running an on-line business, such as providing a domain service 118 associated with their online store, payment services 120 for facilitating transactions with a customer, shipping services 122 for providing customer shipping options for purchased products, risk and insurance services 124 associated with product protection and liability, merchant billing, and the like. Services 116 may be provided via the e-commerce platform 100 or in association with external facilities, such as through a payment gateway 106 for payment processing, shipping providers 112 for expediting the shipment of products, and the like.

In embodiments, the e-commerce platform 100 may provide for integrated shipping services 122 (e.g., through an e-commerce platform shipping facility or through a third-party shipping carrier), such as providing merchants with real-time updates, tracking, automatic rate calculation, bulk order preparation, label printing, and the like.

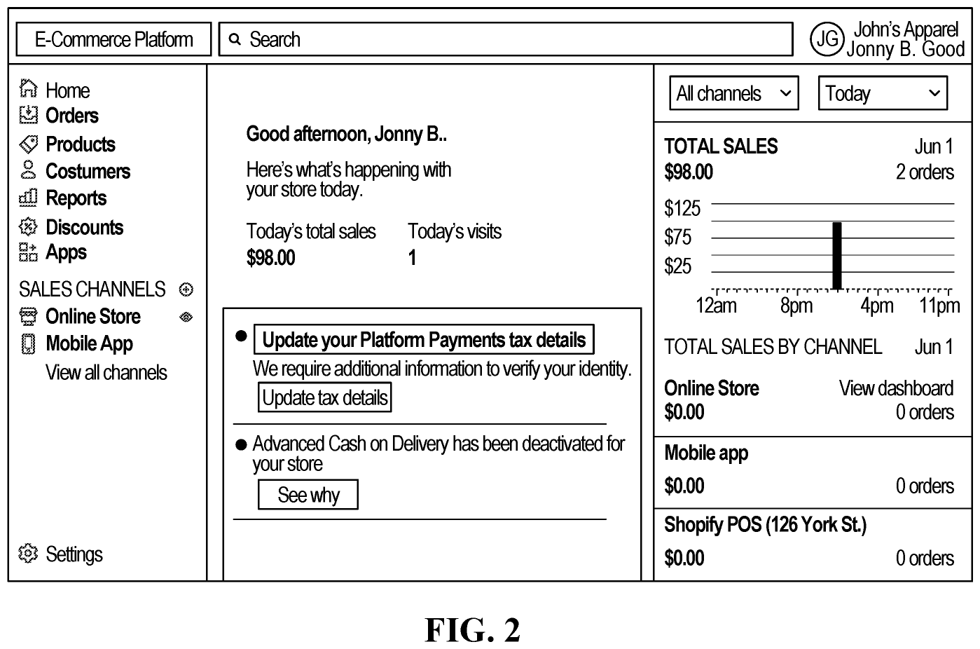

FIG. 2 depicts a non-limiting embodiment for a home page of an administrator 114, which may show information about daily tasks, a store's recent activity, and the next steps a merchant can take to build their business. In embodiments, a merchant may log in to administrator 114 via a merchant device 102 such as from a desktop computer or mobile device, and manage aspects of their online store 138, such as viewing the online store's 138 recent activity, updating the online store's 138 catalog, managing orders, recent visits activity, total orders activity, and the like. In embodiments, the merchant may be able to access the different sections of administrator 114 by using the sidebar, such as shown on FIG. 2. Sections of the administrator 114 may include various interfaces for accessing and managing core aspects of a merchant's business, including orders, products, customers, available reports and discounts. The administrator 114 may also include interfaces for managing sales channels for a store including the online store, mobile application(s) made available to customers for accessing the store (Mobile App), POS devices, and/or a buy button. The administrator 114 may also include interfaces for managing applications (Apps) installed on the merchant's account; settings applied to a merchant's online store 138 and account. A merchant may use a search bar to find products, pages, or other information. Depending on the device 102 or software application the merchant is using, they may be enabled for different functionality through the administrator 114. For instance, if a merchant logs in to the administrator 114 from a browser, they may be able to manage all aspects of their online store 138. If the merchant logs in from their mobile device (e.g. via a mobile application), they may be able to view all or a subset of the aspects of their online store 138, such as viewing the online store's 138 recent activity, updating the online store's 138 catalog, managing orders, and the like.

More detailed information about commerce and visitors to a merchant's online store 138 may be viewed through acquisition reports or metrics, such as displaying a sales summary for the merchant's overall business, specific sales and engagement data for active sales channels, and the like. Reports may include, acquisition reports, behavior reports, customer reports, finance reports, marketing reports, sales reports, custom reports, and the like. The merchant may be able to view sales data for different channels 110A-B from different periods of time (e.g., days, weeks, months, and the like), such as by using drop-down menus. An overview dashboard may be provided for a merchant that wants a more detailed view of the store's sales and engagement data. An activity feed in the home metrics section may be provided to illustrate an overview of the activity on the merchant's account. For example, by clicking on a ‘view all recent activity’ dashboard button, the merchant may be able to see a longer feed of recent activity on their account. A home page may show notifications about the merchant's online store 138, such as based on account status, growth, recent customer activity, and the like. Notifications may be provided to assist a merchant with navigating through a process, such as capturing a payment, marking an order as fulfilled, archiving an order that is complete, and the like.

The e-commerce platform 100 may provide for a communications facility 129 and associated merchant interface for providing electronic communications and marketing, such as utilizing an electronic messaging aggregation facility for collecting and analyzing communication interactions between merchants, customers, merchant devices 102, customer devices 150, POS devices 152, and the like, to aggregate and analyze the communications, such as for increasing the potential for providing a sale of a product, and the like. For instance, a customer may have a question related to a product, which may produce a dialog between the customer and the merchant (or automated processor-based agent representing the merchant), where the communications facility 129 analyzes the interaction and provides analysis to the merchant on how to improve the probability for a sale.

The e-commerce platform 100 may provide a financial facility 120 for secure financial transactions with customers, such as through a secure card server environment. The e-commerce platform 100 may store credit card information, such as in payment card industry data (PCI) environments (e.g., a card server), to reconcile financials, bill merchants, perform automated clearing house (ACH) transfers between an e-commerce platform 100 financial institution account and a merchant's back account (e.g., when using capital), and the like. These systems may have Sarbanes-Oxley Act (SOX) compliance and a high level of diligence required in their development and operation. The financial facility 120 may also provide merchants with financial support, such as through the lending of capital (e.g., lending funds, cash advances, and the like) and provision of insurance. In addition, the e-commerce platform 100 may provide for a set of marketing and partner services and control the relationship between the e-commerce platform 100 and partners. They also may connect and onboard new merchants with the e-commerce platform 100. These services may enable merchant growth by making it easier for merchants to work across the e-commerce platform 100. Through these services, merchants may be provided help facilities via the e-commerce platform 100.

In embodiments, online store 138 may support a great number of independently administered storefronts and process a large volume of transactional data on a daily basis for a variety of products. Transactional data may include customer contact information, billing information, shipping information, information on products purchased, information on services rendered, and any other information associated with business through the e-commerce platform 100. In embodiments, the e-commerce platform 100 may store this data in a data facility 134. The transactional data may be processed to produce analytics 132, which in turn may be provided to merchants or third-party commerce entities, such as providing consumer trends, marketing and sales insights, recommendations for improving sales, evaluation of customer behaviors, marketing and sales modeling, trends in fraud, and the like, related to online commerce, and provided through dashboard interfaces, through reports, and the like. The e-commerce platform 100 may store information about business and merchant transactions, and the data facility 134 may have many ways of enhancing, contributing, refining, and extracting data, where over time the collected data may enable improvements to aspects of the e-commerce platform 100.

Referring again to FIG. 1, in embodiments the e-commerce platform 100 may be configured with a commerce management engine 136 for content management, task automation and data management to enable support and services to the plurality of online stores 138 (e.g., related to products, inventory, customers, orders, collaboration, suppliers, reports, financials, risk and fraud, and the like), but be extensible through applications 142A-B that enable greater flexibility and custom processes required for accommodating an ever-growing variety of merchant online stores, POS devices, products, and services, where applications 142A may be provided internal to the e-commerce platform 100 or applications 142B from outside the e-commerce platform 100. In embodiments, an application 142A may be provided by the same party providing the platform 100 or by a different party. In embodiments, an application 142B may be provided by the same party providing the platform 100 or by a different party. The commerce management engine 136 may be configured for flexibility and scalability through portioning (e.g., sharding) of functions and data, such as by customer identifier, order identifier, online store identifier, and the like. The commerce management engine 136 may accommodate store-specific business logic and in some embodiments, may incorporate the administrator 114 and/or the online store 138.

The commerce management engine 136 includes base or “core” functions of the e-commerce platform 100, and as such, as described herein, not all functions supporting online stores 138 may be appropriate for inclusion. For instance, functions for inclusion into the commerce management engine 136 may need to exceed a core functionality threshold through which it may be determined that the function is core to a commerce experience (e.g., common to a majority of online store activity, such as across channels, administrator interfaces, merchant locations, industries, product types, and the like), is re-usable across online stores 138 (e.g., functions that can be re-used/modified across core functions), limited to the context of a single online store 138 at a time (e.g., implementing an online store ‘isolation principle’, where code should not be able to interact with multiple online stores 138 at a time, ensuring that online stores 138 cannot access each other's data), provide a transactional workload, and the like. Maintaining control of what functions are implemented may enable the commerce management engine 136 to remain responsive, as many required features are either served directly by the commerce management engine 136 or enabled through an interface 140A-B, such as by its extension through an application programming interface (API) connection to applications 142A-B and channels 110A-B, where interfaces 140A may be provided to applications 142A and/or channels 110A inside the e-commerce platform 100 or through interfaces 140B provided to applications 142B and/or channels 110B outside the e-commerce platform 100. Generally, the platform 100 may include interfaces 140A-B (which may be extensions, connectors, APIs, and the like) which facilitate connections to and communications with other platforms, systems, software, data sources, code and the like. Such interfaces 140A-B may be an interface 140A of the commerce management engine 136 or an interface 140B of the platform 100 more generally. If care is not given to restricting functionality in the commerce management engine 136, responsiveness could be compromised, such as through infrastructure degradation through slow databases or non-critical backend failures, through catastrophic infrastructure failure such as with a data center going offline, through new code being deployed that takes longer to execute than expected, and the like. To prevent or mitigate these situations, the commerce management engine 136 may be configured to maintain responsiveness, such as through configuration that utilizes timeouts, queues, back-pressure to prevent degradation, and the like.

Although isolating online store data is important to maintaining data privacy between online stores 138 and merchants, there may be reasons for collecting and using cross-store data, such as for example, with an order risk assessment system or a platform payment facility, both of which require information from multiple online stores 138 to perform well. In embodiments, rather than violating the isolation principle, it may be preferred to move these components out of the commerce management engine 136 and into their own infrastructure within the e-commerce platform 100.

In embodiments, the e-commerce platform 100 may provide for a platform payment facility 120, which is another example of a component that utilizes data from the commerce management engine 136 but may be located outside so as to not violate the isolation principle. The platform payment facility 120 may allow customers interacting with online stores 138 to have their payment information stored safely by the commerce management engine 136 such that they only have to enter it once. When a customer visits a different online store 138, even if they've never been there before, the platform payment facility 120 may recall their information to enable a more rapid and correct check out. This may provide a cross-platform network effect, where the e-commerce platform 100 becomes more useful to its merchants as more merchants join, such as because there are more customers who checkout more often because of the ease of use with respect to customer purchases. To maximize the effect of this network, payment information for a given customer may be retrievable from an online store's checkout, allowing information to be made available globally across online stores 138. It would be difficult and error prone for each online store 138 to be able to connect to any other online store 138 to retrieve the payment information stored there. As a result, the platform payment facility may be implemented external to the commerce management engine 136.

For those functions that are not included within the commerce management engine 136, applications 142A-B provide a way to add features to the e-commerce platform 100. Applications 142A-B may be able to access and modify data on a merchant's online store 138, perform tasks through the administrator 114, create new flows for a merchant through a user interface (e.g., that is surfaced through extensions/API), and the like. Merchants may be enabled to discover and install applications 142A-B through application search, recommendations, and support 128. In embodiments, core products, core extension points, applications, and the administrator 114 may be developed to work together. For instance, application extension points may be built inside the administrator 114 so that core features may be extended by way of applications, which may deliver functionality to a merchant through the extension.

In embodiments, applications 142A-B may deliver functionality to a merchant through the interface 140A-B, such as where an application 142A-B is able to surface transaction data to a merchant (e.g., App: “Engine, surface my app data in mobile and web admin using the embedded app SDK”), and/or where the commerce management engine 136 is able to ask the application to perform work on demand (Engine: “App, give me a local tax calculation for this checkout”).

Applications 142A-B may support online stores 138 and channels 110A-B, provide for merchant support, integrate with other services, and the like. Where the commerce management engine 136 may provide the foundation of services to the online store 138, the applications 142A-B may provide a way for merchants to satisfy specific and sometimes unique needs. Different merchants will have different needs, and so may benefit from different applications 142A-B. Applications 142A-B may be better discovered through the e-commerce platform 100 through development of an application taxonomy (categories) that enable applications to be tagged according to a type of function it performs for a merchant; through application data services that support searching, ranking, and recommendation models; through application discovery interfaces such as an application store, home information cards, an application settings page; and the like.

Applications 142A-B may be connected to the commerce management engine 136 through an interface 140A-B, such as utilizing APIs to expose the functionality and data available through and within the commerce management engine 136 to the functionality of applications (e.g., through REST, GraphQL, and the like) . For instance, the e-commerce platform 100 may provide API interfaces 140A-B to merchant and partner-facing products and services, such as including application extensions, process flow services, developer-facing resources, and the like. With customers more frequently using mobile devices for shopping, applications 142A-B related to mobile use may benefit from more extensive use of APIs to support the related growing commerce traffic. The flexibility offered through use of applications and APIs (e.g., as offered for application development) enable the e-commerce platform 100 to better accommodate new and unique needs of merchants (and internal developers through internal APIs) without requiring constant change to the commerce management engine 136, thus providing merchants what they need when they need it. For instance, shipping services 122 may be integrated with the commerce management engine 136 through a shipping or carrier service API, thus enabling the e-commerce platform 100 to provide shipping service functionality without directly impacting code running in the commerce management engine 136.

Many merchant problems may be solved by letting partners improve and extend merchant workflows through application development, such as problems associated with back-office operations (merchant-facing applications 142A-B) and in the online store 138 (customer-facing applications 142A-B). As a part of doing business, many merchants will use mobile and web related applications on a daily basis for back-office tasks (e.g., merchandising, inventory, discounts, fulfillment, and the like) and online store tasks (e.g., applications related to their online shop, for flash-sales, new product offerings, and the like), where applications 142A-B, through extension/API 140A-B, help make products easy to view and purchase in a fast growing marketplace. In embodiments, partners, application developers, internal applications facilities, and the like, may be provided with a software development kit (SDK), such as through creating a frame within the administrator 114 that sandboxes an application interface. In embodiments, the administrator 114 may not have control over nor be aware of what happens within the frame. The SDK may be used in conjunction with a user interface kit to produce interfaces that mimic the look and feel of the e-commerce platform 100, such as acting as an extension of the commerce management engine 136.

Applications 142A-B that utilize APIs may pull data on demand, but often they also need to have data pushed when updates occur. Update events may be implemented in a subscription model, such as for example, customer creation, product changes, or order cancelation. Update events may provide merchants with needed updates with respect to a changed state of the commerce management engine 136, such as for synchronizing a local database, notifying an external integration partner, and the like. Update events may enable this functionality without having to poll the commerce management engine 136 all the time to check for updates, such as through an update event subscription. In embodiments, when a change related to an update event subscription occurs, the commerce management engine 136 may post a request, such as to a predefined callback URL. The body of this request may contain a new state of the object and a description of the action or event. Update event subscriptions may be created manually, in the administrator facility 114, or automatically (e.g., via the API 140A-B). In embodiments, update events may be queued and processed asynchronously from a state change that triggered them, which may produce an update event notification that is not distributed in real-time.

In embodiments, the e-commerce platform 100 may provide application search, recommendation and support 128. Application search, recommendation and support 128 may include developer products and tools to aid in the development of applications, an application dashboard (e.g., to provide developers with a development interface, to administrators for management of applications, to merchants for customization of applications, and the like), facilities for installing and providing permissions with respect to providing access to an application 142A-B (e.g., for public access, such as where criteria must be met before being installed, or for private use by a merchant), application searching to make it easy for a merchant to search for applications 142A-B that satisfy a need for their online store 138, application recommendations to provide merchants with suggestions on how they can improve the user experience through their online store 138, a description of core application capabilities within the commerce management engine 136, and the like. These support facilities may be utilized by application development performed by any entity, including the merchant developing their own application 142A-B, a third-party developer developing an application 142A-B (e.g., contracted by a merchant, developed on their own to offer to the public, contracted for use in association with the e-commerce platform 100, and the like), or an application 142A or 142B being developed by internal personal resources associated with the e-commerce platform 100. In embodiments, applications 142A-B may be assigned an application identifier (ID), such as for linking to an application (e.g., through an API), searching for an application, making application recommendations, and the like.

The commerce management engine 136 may include base functions of the e-commerce platform 100 and expose these functions through APIs 140A-B to applications 142A-B. The APIs 140A-B may enable different types of applications built through application development. Applications 142A-B may be capable of satisfying a great variety of needs for merchants but may be grouped roughly into three categories: customer-facing applications, merchant-facing applications, integration applications, and the like. Customer-facing applications 142A-B may include online store 138 or channels 110A-B that are places where merchants can list products and have them purchased (e.g., the online store, applications for flash sales (e.g., merchant products or from opportunistic sales opportunities from third-party sources), a mobile store application, a social media channel, an application for providing wholesale purchasing, and the like). Merchant-facing applications 142A-B may include applications that allow the merchant to administer their online store 138 (e.g., through applications related to the web or website or to mobile devices), run their business (e.g., through applications related to POS devices), to grow their business (e.g., through applications related to shipping (e.g., drop shipping), use of automated agents, use of process flow development and improvements), and the like. Integration applications may include applications that provide useful integrations that participate in the running of a business, such as shipping providers 112 and payment gateways.

In embodiments, an application developer may use an application proxy to fetch data from an outside location and display it on the page of an online store 138. Content on these proxy pages may be dynamic, capable of being updated, and the like. Application proxies may be useful for displaying image galleries, statistics, custom forms, and other kinds of dynamic content.

The core-application structure of the e-commerce platform 100 may allow for an increasing number of merchant experiences to be built in applications 142A-B so that the commerce management engine 136 can remain focused on the more commonly utilized business logic of commerce.

The e-commerce platform 100 provides an online shopping experience through a curated system architecture that enables merchants to connect with customers in a flexible and transparent manner. A typical customer experience may be better understood through an embodiment example purchase workflow, where the customer browses the merchant's products on a channel 110A-B, adds what they intend to buy to their cart, proceeds to checkout, and pays for the content of their cart resulting in the creation of an order for the merchant. The merchant may then review and fulfill (or cancel) the order. The product is then delivered to the customer. If the customer is not satisfied, they might return the products to the merchant.

In an example embodiment, a customer may browse a merchant's products on a channel 110A-B. A channel 110A-B is a place where customers can view and buy products. In embodiments, channels 110A-B may be modeled as applications 142A-B (a possible exception being the online store 138, which is integrated within the commence management engine 136). A merchandising component may allow merchants to describe what they want to sell and where they sell it. The association between a product and a channel may be modeled as a product publication and accessed by channel applications, such as via a product listing API. A product may have many options, like size and color, and many variants that expand the available options into specific combinations of all the options, like the variant that is extra-small and green, or the variant that is size large and blue. Products may have at least one variant (e.g., a “default variant” is created for a product without any options). To facilitate browsing and management, products may be grouped into collections, provided product identifiers (e.g., stock keeping unit (SKU)) and the like. Collections of products may be built by either manually categorizing products into one (e.g., a custom collection), by building rulesets for automatic classification (e.g., a smart collection), and the like. Products may be viewed as 2D images, 3D images, rotating view images, through a virtual or augmented reality interface, and the like.

In embodiments, the customer may add what they intend to buy to their cart (in an alternate embodiment, a product may be purchased directly, such as through a buy button as described herein). Customers may add product variants to their shopping cart. The shopping cart model may be channel specific. The online store 138 cart may be composed of multiple cart line items, where each cart line item tracks the quantity for a product variant. Merchants may use cart scripts to offer special promotions to customers based on the content of their cart. Since adding a product to a cart does not imply any commitment from the customer or the merchant, and the expected lifespan of a cart may be in the order of minutes (not days), carts may be persisted to an ephemeral data store.

The customer then proceeds to checkout. A checkout component may implement a web checkout as a customer-facing order creation process. A checkout API may be provided as a computer-facing order creation process used by some channel applications to create orders on behalf of customers (e.g., for point of sale). Checkouts may be created from a cart and record a customer's information such as email address, billing, and shipping details. On checkout, the merchant commits to pricing. If the customer inputs their contact information but does not proceed to payment, the e-commerce platform 100 may provide an opportunity to re-engage the customer (e.g., in an abandoned checkout feature). For those reasons, checkouts can have much longer lifespans than carts (hours or even days) and are therefore persisted. Checkouts may calculate taxes and shipping costs based on the customer's shipping address. Checkout may delegate the calculation of taxes to a tax component and the calculation of shipping costs to a delivery component. A pricing component may enable merchants to create discount codes (e.g., ‘secret’ strings that when entered on the checkout apply new prices to the items in the checkout). Discounts may be used by merchants to attract customers and assess the performance of marketing campaigns. Discounts and other custom price systems may be implemented on top of the same platform piece, such as through price rules (e.g., a set of prerequisites that when met imply a set of entitlements). For instance, prerequisites may be items such as “the order subtotal is greater than $100” or “the shipping cost is under $10”, and entitlements may be items such as “a 20% discount on the whole order” or “$10 off products X, Y, and Z”.

Customers then pay for the content of their cart resulting in the creation of an order for the merchant. Channels 110A-B may use the commerce management engine 136 to move money, currency or a store of value (such as dollars or a cryptocurrency) to and from customers and merchants. Communication with the various payment providers (e.g., online payment systems, mobile payment systems, digital wallet, credit card gateways, and the like) may be implemented within a payment processing component. The actual interactions with the payment gateways 106 may be provided through a card server environment. In embodiments, the payment gateway 106 may accept international payment, such as integrating with leading international credit card processors. The card server environment may include a card server application, card sink, hosted fields, and the like. This environment may act as the secure gatekeeper of the sensitive credit card information. In embodiments, most of the process may be orchestrated by a payment processing job. The commerce management engine 136 may support many other payment methods, such as through an offsite payment gateway 106 (e.g., where the customer is redirected to another website), manually (e.g., cash), online payment methods (e.g., online payment systems, mobile payment systems, digital wallet, credit card gateways, and the like), gift cards, and the like. At the end of the checkout process, an order is created. An order is a contract of sale between the merchant and the customer where the merchant agrees to provide the goods and services listed on the orders (e.g., order line items, shipping line items, and the like) and the customer agrees to provide payment (including taxes). This process may be modeled in a sales component. Channels 110A-B that do not rely on commerce management engine 136 checkouts may use an order API to create orders. Once an order is created, an order confirmation notification may be sent to the customer and an order placed notification sent to the merchant via a notification component. Inventory may be reserved when a payment processing job starts to avoid over-selling (e.g., merchants may control this behavior from the inventory policy of each variant). Inventory reservation may have a short time span (minutes) and may need to be very fast and scalable to support flash sales (e.g., a discount or promotion offered for a short time, such as targeting impulse buying). The reservation is released if the payment fails. When the payment succeeds, and an order is created, the reservation is converted into a long-term inventory commitment allocated to a specific location. An inventory component may record where variants are stocked, and tracks quantities for variants that have inventory tracking enabled. It may decouple product variants (a customer facing concept representing the template of a product listing) from inventory items (a merchant facing concept that represent an item whose quantity and location is managed). An inventory level component may keep track of quantities that are available for sale, committed to an order or incoming from an inventory transfer component (e.g., from a vendor).

The merchant may then review and fulfill (or cancel) the order. A review component may implement a business process merchant's use to ensure orders are suitable for fulfillment before actually fulfilling them. Orders may be fraudulent, require verification (e.g., ID checking), have a payment method which requires the merchant to wait to make sure they will receive their funds, and the like. Risks and recommendations may be persisted in an order risk model. Order risks may be generated from a fraud detection tool, submitted by a third-party through an order risk API, and the like. Before proceeding to fulfillment, the merchant may need to capture the payment information (e.g., credit card information) or wait to receive it (e.g., via a bank transfer, check, and the like) and mark the order as paid. The merchant may now prepare the products for delivery. In embodiments, this business process may be implemented by a fulfillment component. The fulfillment component may group the line items of the order into a logical fulfillment unit of work based on an inventory location and fulfillment service. The merchant may review, adjust the unit of work, and trigger the relevant fulfillment services, such as through a manual fulfillment service (e.g., at merchant managed locations) used when the merchant picks and packs the products in a box, purchase a shipping label and input its tracking number, or just mark the item as fulfilled. A custom fulfillment service may send an email (e.g., a location that doesn't provide an API connection). An API fulfillment service may trigger a third party, where the third-party application creates a fulfillment record. A legacy fulfillment service may trigger a custom API call from the commerce management engine 136 to a third party (e.g., fulfillment by Amazon). A gift card fulfillment service may provision (e.g., generating a number) and activate a gift card. Merchants may use an order printer application to print packing slips. The fulfillment process may be executed when the items are packed in the box and ready for shipping, shipped, tracked, delivered, verified as received by the customer, and the like.

If the customer is not satisfied, they may be able to return the product(s) to the merchant. The business process merchants may go through to “un-sell” an item may be implemented by a return component. Returns may consist of a variety of different actions, such as a restock, where the product that was sold actually comes back into the business and is sellable again; a refund, where the money that was collected from the customer is partially or fully returned; an accounting adjustment noting how much money was refunded (e.g., including if there was any restocking fees, or goods that weren't returned and remain in the customer's hands); and the like. A return may represent a change to the contract of sale (e.g., the order), and where the e-commerce platform 100 may make the merchant aware of compliance issues with respect to legal obligations (e.g., with respect to taxes). In embodiments, the e-commerce platform 100 may enable merchants to keep track of changes to the contract of sales over time, such as implemented through a sales model component (e.g., an append-only date-based ledger that records sale-related events that happened to an item).

Systems and Methods Making Use of Inventory Information with the Objective of Managing Inventory Across a network of Stores.

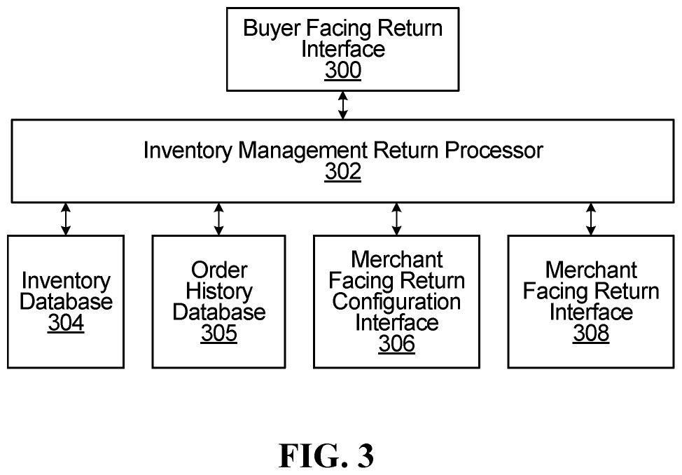

Referring to FIG. 3, shown is block diagram of a return processing system provided by an embodiment of the invention. The system includes a buyer facing return interface 300 connected to an inventory management return processor 302. The inventory management return processor 302 is also connected to an inventory database 304, a merchant facing return configuration interface 306, and a merchant facing return interface 308. Optionally, the inventory management return processor 302 is also connected to an order history database 305 containing details of previous orders. While the description refers to various components being connected to each other, it should be understood that a direct connection is not necessary. For example, the buyer facing return interface 300 may be connected to the interface management return processor 302 over a network. In addition, one or more of the components of FIG. 3 may be combined.

The return processing system of FIG. 3 can be implemented within a system such as that described with reference to FIG. 1. In this case, the buyer facing return interface 300 may be implemented on the customer device 150. If it is an APP, the APP may be made available from the merchant or through other channels. Alternatively, the buyer facing return interface 300 may be in the form of a web page/GUI served directly from e-commerce platform. The inventory management return processor 302 may be implemented in the e-commerce platform, either as a dedicated processor, or as functionality within the commerce management engine. The merchant facing return interface 308 maybe be available at multiple different locations, and may, for example, be implemented in the POS device 152. The merchant facing return configuration interface 308 may, for example, be made available on a merchant device 102, merchant off platform website 104, or other location accessible by the merchant to configure the return processing.

The purpose of the buyer facing return interface 300 is for the system to learn from the buyer details of the item being returned. This interface is used to collect information concerning the item being returned, such as identifying information or identifier (e.g. item ID, Stock Keeping Unit (SKU) and/or other (machine readable) identifying information or code, etc.), a reason for the return, a condition or quality of the item (e.g. new, in packaging, without packaging, damaged, etc.). The interface may also be used to collect information concerning the buyer, such as buyer name, address, purchase history, etc. The information is conveyed, in the form of a return indication, to the inventory management return processor 302. In response, the buyer facing return interface 302 receives, from the inventory management return processor 302, a return location for the item being returned, and conveys this to the buyer. In some embodiments, this is simply an indication, presented to the buyer through the buyer facing return interface 302, of the return location that the buyer should visit to return the item.

### Buyer Facing Return Interface

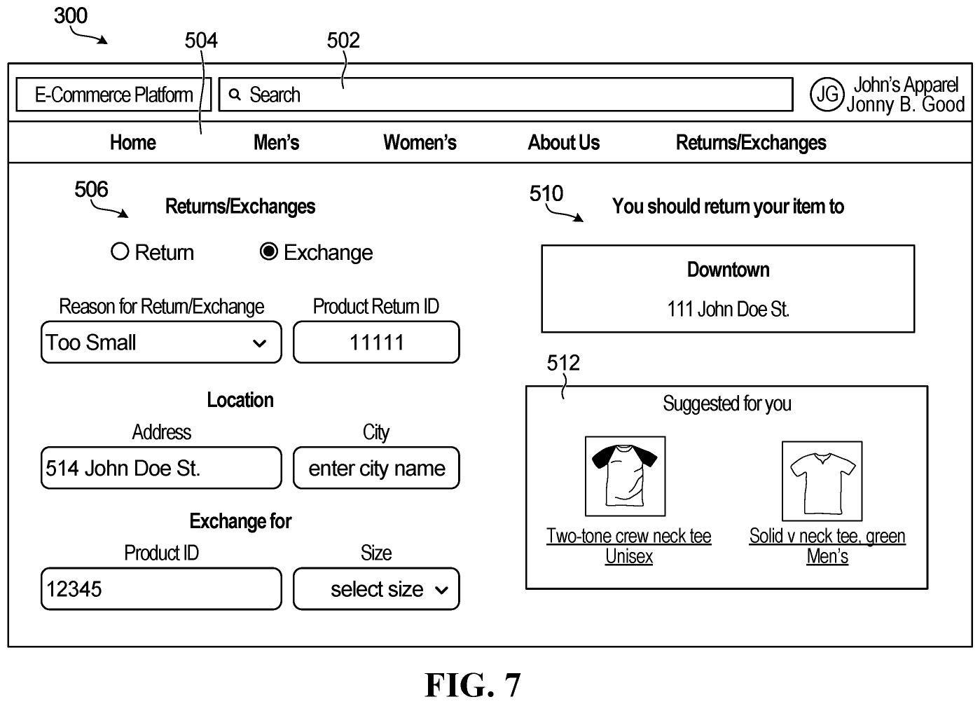

In some embodiments, the buyer facing return interface 300 is provided within an online portal, such as a web page, associated with the merchant, that is served to a buyer on a client device such as computer or a mobile device. In another embodiment, the facing return interface 300 is an app configured on a mobile device. An example of a GUI for the buyer facing return interface is provided in FIG. 7, described in detail below.

In some embodiments, where the item was purchased as part of an order for which an order receipt was issued, the order receipt (which may be physically provided to the buyer, or sent to the buyer through some other channel, such as email) contains a link to a web page implementing the buyer facing return interface. Optionally, the link is uniquely associated with the order, such that when the buyer selects the link, the system will be aware of the order. In this case, some or all of the information from the order is autopopulated into the buyer facing return interface 300.

### Inventory Management Return Processor

The inventory management return processor 302 receives a return indication from the buyer facing return interface 302, the return indication containing the information collected by the buyer facing return interface 300. Based on this information, and the information in the inventory database 304, the inventory management return processor 302 selects a return location for the item to be returned to, and conveys this back to the buyer facing return interface 302. For the purpose of this description, the selected location will be referred to herein as an inventory management return location. However, alternatively, the selected location can be conveyed to the buyer through other means, for example physical mail, or electronically, including through a web page, portal, electronic mail, text message to name a few examples.

Various different logic may be applied in selecting the inventory management return location, and various examples of this are described in detail below.

### Inventory Database

The inventory database 304 contains inventory information for multiple return locations. In some embodiments, the return locations are retail points of sale, but they need not necessarily be. Alternatively, they could be dedicated return facilities, or warehouses. The inventory information may include information such as one or more of:

Current inventory per return location per item identifier;

Turnover per return location per item identifier, for example average sales over a defined period of time; and

Physical location of the return location.

More generally, the inventory database 304 contains information to assist the inventory management return processor 302 to make a selection of an inventory management return location based on whatever logic is implemented in the inventory management return processor.

In some embodiments, the inventory database 304 is not dedicated to return processing, but rather is the inventory database already maintained for the merchant. In some embodiments, a new API is provided to access the inventory database 304 from the inventory management return processor 302 for the purpose of extracting the necessary information from the inventory database 304 in an efficient manner.

### Order History Database

The order history database 305 contains details of previous orders. In some embodiments, each order is indexed by order ID, but it may also be indexed and/or searchable by buyer, item ID or other information. In some embodiments, the order history database 305 contains sales history per item per return location, maintained for a period of time defined by a sliding time window.

In some embodiments, the order history database 305 is not dedicated to return processing, but rather is the order history database already maintained for the merchant. In some embodiments, a new API is provided to access the order history database 305 from the inventory management return processor 302 for the purpose of extracting the necessary information from the order history database in an efficient manner.

### Merchant Facing Return Configuration Interface

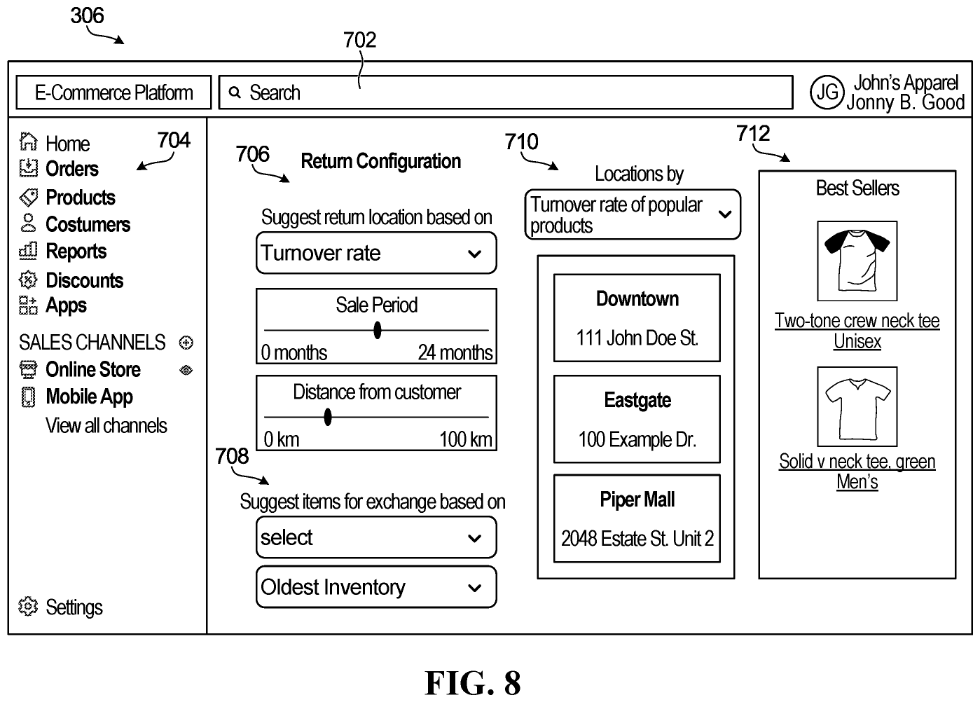

The merchant facing return configuration interface 306 is an interface through which a merchant can configure the behaviour of the inventory management return processor 302. This can involve selecting a particular method applied by the inventory management return processor 302 to select the inventory management return location and/or configuring a method applied by the inventory management return processor 302, for example by configuring parameters of the method. An example of a GUI for the merchant facing return configuration interface is provided in FIG. 8, described in detail below.

### Merchant Facing Return Interface

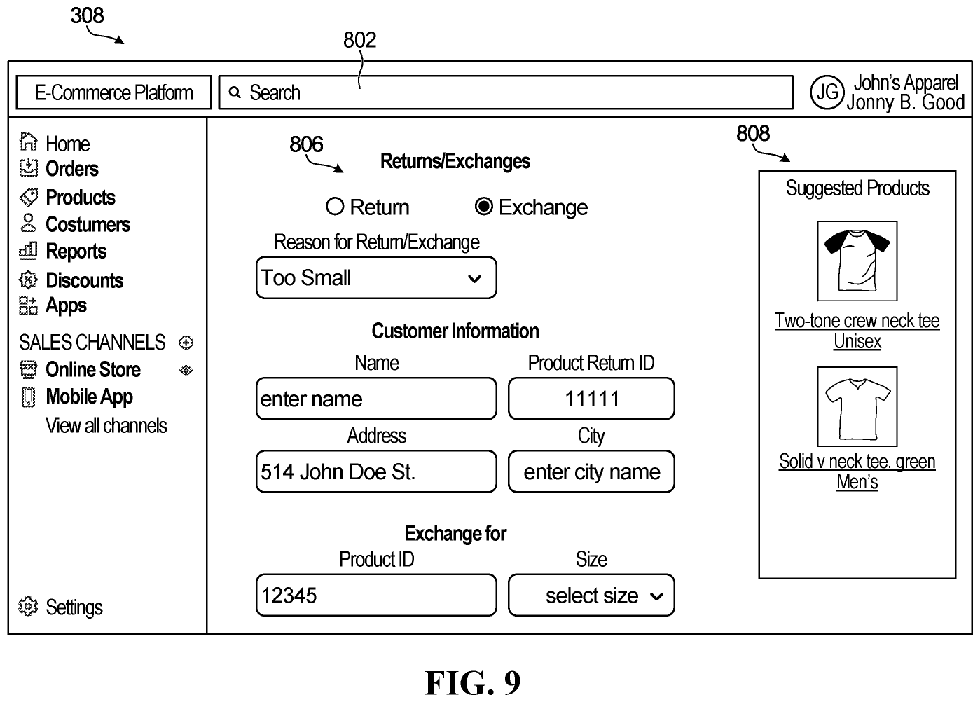

The merchant facing return interface 306 is an interface through which a merchant can process returns. This may, for example, be implemented in a point of sale terminal. An Example GUI for the merchant facing return interface is shown in FIG. 9 and described below.

Various examples of methods that may be used by the inventory management return processor 302 to select the return location will now be described.

In some embodiments, the inventory management return processor 302 selects the return location having the lowest inventory for the item being returned among return locations within a defined distance of the buyer location.

In some embodiments, the inventory management return processor 302 selects the return location having the lowest inventory for the item among all possible return locations.

In some embodiments, the inventory management return processor 302 has the further option of selecting to return the item to a targeted location, selected by the merchant, which could, for example, constitute a charitable organization for receipt of a return item. In some embodiments, this decision is still made based on the related inventory information. For example, if there is no urgent need for the item at any nearby location, it may be an opportunity to ship the item to a charitable organization. In some embodiments, the inventory management return processor 302 is further configured to select a targeted location selected by the merchant (e.g. a charitable organization) when a quality or the item is indicated as being other than new (e.g. without packaging, damaged, etc.) and/or the reason for the return indicates that the item cannot be resold as new (e.g. damaged, does not work, etc.)

In some embodiments, the inventory management return processor 302 selects the return location based on a metric. In a specific example, a metric is computed for each return location according to a weighted combination that increased with decreasing inventory, and that increases with increasing sales history of a defined period:

```
  Metric(store_i) = K / {current inventory(item, store_i) + 1} + M ×
Number of sales (item,store_i, sales_period)
    where:
  K and M are configured weights;
    store_i is a store ID;
    current inventory(item, store_i) is the inventory of the item, at
store_i;
    Number of sales (item,store_i, sales_period) is the number of sales
of the item at store having store ID store_i, over a configured time
period = sales_period.
```

This metric is computed for each return location, and the return location with the larges metric is selected. Optionally, K and M are configured in the merchant facing return configuration interface 306. The current inventory can be obtained from the inventory database 304, and the number of sales can be obtained from the order history database 305. This is a specific example of a metric. Other metrics can be used instead.

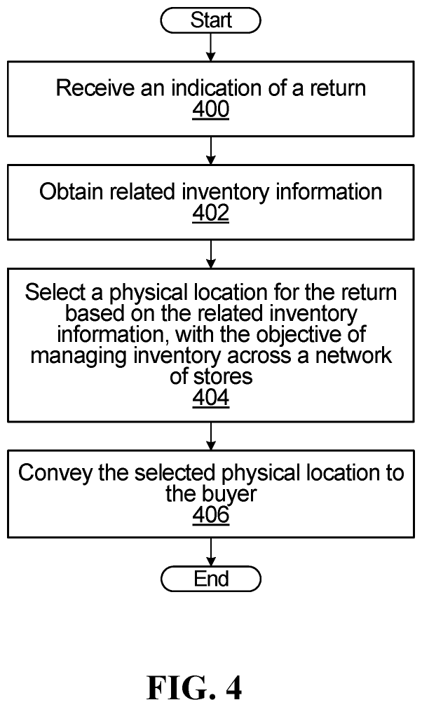

Referring now to FIG. 4, shown is a flowchart of a method of processing returns, provided by an embodiment of the invention.

The method begins at block 400 with the merchant receiving an indication of a return. This can, for example, occur through a buyer facing return interface.

In block 402, related inventory information is obtained in respect of the return.

In block 404, a physical location for the return is selected based on the related inventory information, with the objective of managing inventory across a network of stores.

In block 406, the physical location for the return is conveyed to the buyer.

### Online Returns

In another embodiment, inventory management return location is conveyed to the buyer in the form of a shipping label or a labeled return container send to the buyer's physical address, or in the form of printable shipping label provided to the buyer electronically. More generally, this can include sending to the buyer one of the following:

a physical shipping label or return container imprinted with a physical return address or coordinate location;

a physical shipping label or return container imprinted with a logistics identifier associated with the selected physical return location;

a physical shipping label or return container imprinted with a barcode associated with the selected physical return location;

a printable shipping label, sent electronically, containing a physical return address or coordinate location;

a printable shipping label, sent electronically, containing a logistics identifier associated with the selected physical return location;

a printable shipping label, sent electronically, containing a barcode associated with the selected physical return location; and an attachable device associated with the selected physical return location, for example, an IoT (internet of things) chipset.

The return location can be selected by the inventory management return processor 302, as before, and rather than simply indicating the store location to the buyer for use by the buyer to physically return the item, the buyer uses the shipping label to ship the item back to the indicated address. Optionally this decision is also based on shipping cost of return, given the cost of shipping to different return locations is not necessarily equal. Various approaches may be used to combine the effect of cost, with the objective of inventory management. For example, a metric that is a weighted sum of a cost component and an inventory management component may be calculated for various store locations. Once the metrics are calculated the store can be selected based on the metrics. In a specific example, the following metric is computed:

```
    Metric(store_i) = P × inventory management metric (item, store_i) -
Q(shipping cost(item, store_i)
    where:
    P and Q are configured weights;
    store_i is a store ID;
    inventory management metric (item, store_i) is an inventory
management metric for the item at store_i;
  shipping cost(item, store_i) is an estimated shipping cost of returning
the item to store_i
```

This metric is computed for each return location, and the return location with the larges metric is selected. Optionally, P and Q are configured in the merchant facing return configuration interface 306.

Systems and Methods Making Use of Inventory Information with the Objective of Enhancing Probability of Converting a Return into an Exchange.

In this embodiment, inventory information is used in the return processing with the objective of enhancing probability of converting a return into an exchange. In this case, related inventory is information regarding the item, different sizes, options etc. for the item at various physical store locations. The system makes use of this information to send the buyer to a specific store with the inventory that has the best chance of converting the return into an exchange. This store selection will be referred to herein as an exchange likelihood enhancement store selection.

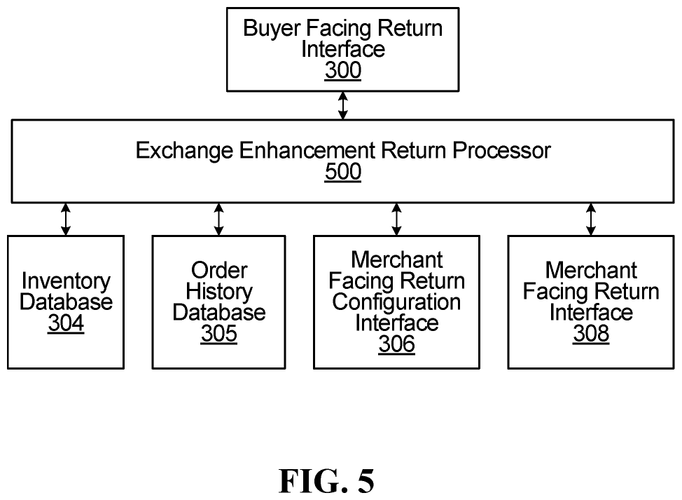

Referring to FIG. 5, shown is block diagram of a return processing system provided by an embodiment of the invention. The system is similar to that of FIG. 3, but inventory management return processor 302 is replaced with exchange enhancement return processor 502. The functionalities of the components of FIG. 5 are similar to those of FIG. 3 with differences noted below.

In a similar manner to the return processing system of FIG. 3, the return processing system of FIG. 5 can be implemented within a system such as that described with reference to FIG. 1. In this case, the exchange enhancement return processor 500 may be implemented in the e-commerce platform, either as a dedicated processor, or as functionality within the commerce management engine.

As before, the exchange enhancement return processor 502 receives a return indication from the buyer facing return interface 302, the return indication containing the information collected by the buyer facing return interface 300. Based on this information, and the information in the inventory database 304, the return enhancement return processor 502 selects a return location for the item to be returned to, and conveys this back to the buyer facing return interface 302. This is referred to as an exchange enhancement return location. The exchange enhancement return location is selected, by the exchange enhancement return processor 502, to increase the likelihood of converting the return into an exchange.

The buyer facing return interface 302 receives, from the return enhancement return processor 302, the return location for the item being returned, and conveys this to the buyer. In some embodiments, this is simply an indication, presented to the buyer through the buyer facing return interface 302, of the return location that the buyer should visit to return the item.

The inventory database 304 contains inventory information for multiple return locations. In addition to the inventory information described for the embodiment of FIG. 3, for the embodiment of FIG. 5, the inventory information may include one or more of:

Current inventory of items related to the item being returned: this can include, for example, inventory for different sizes of the same item, inventory for different colours of the same item, inventory for other similar items.

Various methods can be applied by the exchange enhancement return processor 502 to select the exchange enhancement return location. In a specific example, a metric is computed for each store location that is a weighted sum of one or more of the following:

Store inventory for one size larger;

Store inventory for one size smaller;

Store inventory for same item in different colour; and

Store inventory for different style of item in same size.

However, it should be understood that given a complete inventory information for an item and items related to the item (where an item is related either through preconfigured or configured relationship), many different ways of processing the information to select an exchange enhancement return location can be implemented.

In some embodiments, some or all of the inventory information is surfaced to the buyer through the buyer facing return interface. This way, even before the buyer heads to the store, the buyer is aware of the other products that are available at the store.

In some embodiments, the buyer facing return interface 302 is configured to receive an indication from the buyer that an exchange is desired. The buyer can specify that he/she wants to exchange the item for some other specific other product. Then system can tell you where to go for the exchange based on the inventory for the other product, and/or based on inventory for items related to the item being returned.

In some embodiments, where an exchange is selected the system provides the buyer with the information necessary to make the exchange, but where exchange is not selected, the system still pre-emptively looks up the exchange info, sends the buyer to return location that has related inventory in stock so that the buyer can be sold on the exchange even though they originally just wanted to do the return.

In some embodiments, some or all of the inventory information and/or information about buyer purchase history is surfaced to the sales agent at a point of sale location to assist the sales agent with converting the return into an exchange and/or upselling or cross selling. In a specific example, once a receipt/order for the item is scanned at the merchant point of sale location, the system provides the inventory information on a screen at the merchant point of sale location. This information is available for the sales agent handling the return to convey to the buyer. The merchant point of sale system may include:

a user interface to scan the receipt or otherwise get the buyer/item information;

a processor configured to obtain and display related inventory information.

Similar functionality may be provided in an external tool or an app.

As before, the order history database 305 contains details of previous orders. In some embodiments, the order history database 305 contains details of previous orders by each buyer. In some embodiments, the order history for the buyer is factored into the selection of the exchange enhancement return location. For example, if the particular buyer has a history, based on the order history, of purchasing a particular item that satisfies some criteria (e.g. number of purchases, total value, etc.) then a metrics for a location that have that particular item in stock can be weighted accordingly to favour selection of that location.

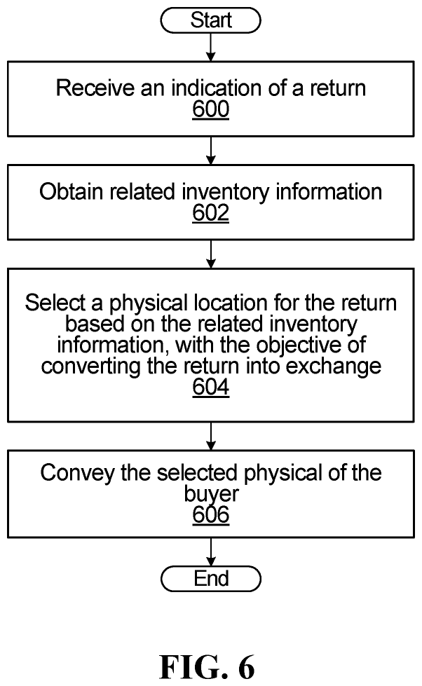

Referring now to FIG. 6, shown is a flowchart of a method of processing returns, provided by an embodiment of the invention.

The method begins at block 600 with the merchant receiving an indication of a return.

In block 602, related inventory information is obtained in respect of the return.

In block 604, a physical location for the return is selected based on the related inventory information, with the objective of converting the return into an exchange.

In block 606, the physical location for the return is conveyed to the buyer.

Optionally, this method is combined with the method that produced the exchange likelihood enhancement store selection. Various methods for combining the two approaches are provided.

In a first embodiment, a default selection for the buyer to return/exchange the item is determined based on exchange enhancement, but a merchant is given an option of overriding and selecting a load balancing store selection.

### Buyer Facing Return Interface GUI Example

FIG. 7 illustrates an example of agraphical user interface (GUI) that may be implemented as the buyer facing return interface 300, according to one implementation. The interface may include a search bar 502 which is capable of using keywords to locate information on the online store, app, or other interface which may include products, shipping information, or other information regarding the merchant or products offered. A selection of site headers 504 may be implemented for convenient navigation of the site.

The GUI, according to one implementation, includes a return selection menu 506 which is configured by the merchant to request the information relevant to their preferred method of selecting the return location. The return selection menu 506 may include drop-down menus, empty fields, and/or selection boxes, and may request information such as whether a return or exchange is desired, the reason(s) for said return or exchange, location information (e.g. Address, Postal code, Zip code), and/or other information requested by the merchant based on their configuration. An exchange selection menu 508 may be included as part of the GUI and may consist of drop-down menus, empty fields, and/or selection boxes. The user may request an item to exchange for in the exchange selection menu 508, and may be asked to input such details as a product name or ID, size, colour, style, or other information.

A suggested return location field 510 is included as a part of the GUI. Said field displays the retail location that they buyer is to visit to return or exchange items. The retail location displayed is determined based on the preferences configured by the merchant and may rely on the information input by the user. The GUI may also show a selection of suggested products for exchange 512 which may be displayed whether or not an exchange is desired. Products displayed are based on various criteria that may include one or more of current inventory of related products, a user's previous site activity (e.g. searches, products viewed), better versions of the product being returned, alternatives to the product being returned, previously bought products, interests of similar customers, or information entered into the fields of the exchange selection interface 508. Such products are displayed to pique a user's interest and increase the likelihood of an exchange or future purchase. In some embodiments, the selection of the products to be presented as suggested products is configurable through the merchant facing return configuration interface.

### Merchant Facing Return Configuration Interface GUI Example

FIG. 8 illustrates an example of a GUI that may be used as implemented a merchant facing return configuration interface 306. This GUI may be implemented as part of an online store, app, or other interface. The GUI includes a search bar 702 which is capable of using keywords to locate information on the online store, app, or other interface which may include products, sales data, settings, or other information. A sidebar menu 704 is included in the GUI as a potential navigation tool to provide shortcuts to other pages (e.g. orders, product pages, financial information).

A return configuration menu 706 is included as a part of the GUI. Said menu may include tools such as empty fields, selection boxes, drop down selection menus, and/or slider selections. Here the merchant may select which criteria is to be used or prioritized when selecting a return location, such as the current inventory, the turnover rate, the distance to the customer, or some metric or combination of criteria. In some embodiments, the drop down menu allows a selection between return location based on enhancing likelihood of exchange, and return location based on inventory management, or return location based on inventory management subject to merchant over-ride, or return location based on enhancing likelihood of exchange subject to merchant override. The return configuration menu 706 may include input for maximum distance to client, the sales period to consider, and/or weights used in a metric. The GUI may also include an exchange criteria menu 708, used to configure selection criteria for products are to be offered to users for exchange. For example, exchange criteria may be configured to suggest a product similar to the one returned but in a different size or colour, related to a previously purchased product, or purchased by other, similar customers.

The GUI displays retail locations 710, which are sorted based on the preferences entered in the return configuration menu 706 (e.g. turnover rate of a certain product, proximity to a location, inventory). The GUI may include a selection of suggested products 712, which may display products based on high or low inventory, high turnover rates, or other criteria entered in exchange criteria menu 708. For example, the suggest products 712 may include better versions of the product being returned, better suited products, etc. These can then be made available at the merchant facing return interface (as described below) so as to provide the merchant with an opportunity to upsell the user on one of such products at the time that the consumer returns the product to the merchant retail location.

Merchant facing return interface GUI Example

FIG. 9 illustrates an example of a GUI that may be used as the merchant facing return interface 308, according to one embodiment. This GUI may be implemented as part of an online store, app, POS terminal, or another interface. The GUI includes a search bar 802 which is capable of using keywords to locate information on the online store, app, or other interface which may include products, sales data, settings, or other information. A sidebar menu 804 is included in the GUI as a potential navigation tool to provide shortcuts to other pages (e.g. orders, product pages, financial information).

The GUI includes a return/exchange processing menu 806 which may include may include drop-down menus, empty fields, and/or selection boxes. Customer information is recorded here, as is the information regarding the product that is to be returned. Furthermore, information of a product to be exchanged for may also be recorded. The GUI may also display a selection of suggested products for exchange 808 which are displayed according to criteria configured by the merchant in the merchant facing return configuration interface 306. The suggested products for exchange 808 may display products according to current inventory, a user's previous purchases, similar customers, or a variation of the item returned. For example, the suggest products for exchange 808 may be include better versions of the product being returned, better suited products, etc. In some embodiments, the selection of the suggested products is configurable through the merchant facing return configuration interface.

Numerous modifications and variations of the present disclosure are possible in light of the above teachings. It is therefore to be understood that within the scope of the appended claims, the disclosure may be practiced otherwise than as specifically described herein.

1. A computer implemented method of processing a return indication, the method comprising:
receiving an indication of a return of an item;
obtaining related inventory information;
selecting a physical return location for returning the item based on the related inventory information, wherein selecting the physical return location is based on inventory management;
conveying an output associated with the selected physical return location by sending a shipping label or attachable device associated with the selected physical return location.

2. The method of claim 1 wherein conveying an output associated with the selected physical return location by sending a shipping label or attachable device associated with the selected physical return location comprises sending a physical shipping label associated with the selected physical return location.

3. The method of claim 2 wherein the physical shipping label is imprinted with a physical return address of the selected physical return location.

4. The method of claim 2 wherein the physical shipping label is imprinted with a barcode of the selected physical return location.

5. The method of claim 2 wherein the physical shipping label is imprinted with a logistics identifier associated with the selected physical return location.

6. The method of claim 1 wherein conveying an output associated with the selected physical return location by sending a shipping label or attachable device associated with the selected physical return location comprises sending electronically a printable shipping label associated with the selected physical return location.

7. The method of claim 6 wherein the printable shipping label contains a physical return address of the selected physical return location.

8. The method of claim 6 wherein the printable shipping label contains a barcode of the selected physical return location.

9. The method of claim 6 wherein the printable shipping label contains a logistics identifier associated with the selected physical return location.

10. The method of claim 1 wherein conveying an output associated with the selected physical return location by sending a shipping label or attachable device associated with the selected physical return location comprises sending an attachable device associated with the selected physical return location, the attachable device comprising an IoT (internet of things) chipset.

11. The method of claim 1 where obtaining the related inventory information involves using a related inventory API.

12. A system for processing a return indication, the system comprising:
an interface for receiving an indication of a return of an item;
an inventory database containing inventory for a set of physical return locations;
a processor and memory configured to process the received return indication by:
obtaining related inventory information from the inventory database;
selecting a physical return location for returning the item based on the related inventory information, wherein selecting the physical return location is based on inventory management;
conveying an output associated with the selected physical return location by sending a shipping label or attachable device associated with the selected physical return location.

13. The system of claim 12 configured to convey an output associated with the selected physical return location by sending a shipping label or attachable device associated with the selected physical return location by sending a physical shipping label associated with the selected physical return location.

14. The system of claim 13 wherein the physical shipping label is imprinted with a physical return address of the selected physical return location.

15. The system of claim 13 wherein the physical shipping label is imprinted with a barcode of the selected physical return location.

16. The system of claim 13 wherein the physical shipping label is imprinted with a logistics identifier associated with the selected physical return location.

17. The system of claim 12 configured to convey an output associated with the selected physical return location by sending a shipping label or attachable device associated with the selected physical return location by sending electronically a printable shipping label associated with the selected physical return location.

18. The system of claim 17 wherein the printable shipping label contains a physical return address of the selected physical return location.

19. The system of claim 17 wherein the printable shipping label contains a barcode of the selected physical return location.

20. The system of claim 17 wherein the printable shipping label contains a logistics identifier associated with the selected physical return location.

21. The system of claim 12 configured to convey an output associated with the selected physical return location by sending a shipping label or attachable device associated with the selected physical return location by sending an attachable device associated with the selected physical return location, the attachable device comprising an IoT (internet of things) chipset.

22. The system of claim 12 comprising a related inventory API for use in obtaining the related inventory information.
